(19) United States
(12) Patent Application Publication
(10) Pub. No.: US 2003/0015841 A1
(43) Pub. Date: Jan. 23, 2003

(54) Adaptable air gap baffle seal and system

(75) Inventor: Charles M. Rowe, Orlando, FL (US)

Correspondence Address: Siemens Corporation, Intellectual Property Department, 186 Wood Avenue South, Iselin, NJ, 08830, US

(73) Assignee: Siemens Westinghouse Power Corporation

(21) Appl. No.: 09/910,220

(22) Filed: Jul. 20, 2001

(51) Int. Cl. F16J 15/34

(52) U.S. Cl. 277/370

(57) ABSTRACT

A seal system by which a seal located within a confined space can be worked. The seal system includes an access structure having a positioning channel removably attached to a first element, and a second element set apart from the first element to provide a gap between the first element and the second element. The seal system also includes a securement portion sized and configured to be accepted into and retained by the positioning channel of the access structure and/or the first element. By this configuration, the seal can attain a service orientation, where the seal does not appreciably obstruct the gap, and an operation orientation, where the seal can completely obstruct or essentially completely obstruct the gap. By this configuration, the seal can also be contorted or moved into a protected area to make room for another object.

### FIELD OF THE INVENTION

The present invention relates in general to an adaptable seal, and more particularly, to an adaptable air gap baffle seal that can be accessed and/or contorted without removing a generator rotor from the generator in a power generation plant.

### BACKGROUND OF THE INVENTION

Many power generation plants produce electricity by converting energy (e.g. fossil fuel, nuclear fission, hydraulic head, geothermal heat) into mechanical energy (e.g. rotation of a turbine shaft), and then converting the mechanical energy into electrical energy (e.g. by the principles of electromagnetic induction). Fossil fuel power generation plants typically use a turbine to convert the fossil fuels into mechanical energy and a generator to convert the mechanical energy into electricity.

One aspect of the above-described power generation scheme involves an air gap baffle seal located in or near the air gap between the generator's rotor and the generator's stator. The air gap baffle seal directs coolant (e.g. air, hydrogen) flow through the rotor windings so that the windings do not reach harmful temperatures. To perform its function, the air gap baffle seal must block incoming coolant from passing directly into the air gap and redirect it through the windings.

For a variety of reasons, many generators have been and continue to be configured such that the air gap baffle seal is set inward a distance of about 3-7 feet from an end of the generator winding, on the edge of the core or on the winding. Due to space constraints (heights and widths of a few feet to a few inches), access to the seal is difficult with the rotor in place. Moreover, when the seal must be inspected, repaired, replaced, adjusted etc. (hereinafter “worked”), the confined space problem is exasperated.

Oftentimes, the only way to work the seal is to remove the rotor from the generator. However, removing the rotor from the generator is a time consuming, risky and costly undertaking involving sliding the rotor onto a skid plate and out of the generator with the assistance of a crane. As the skid plate and rotor moves, the seal can quite easily become ripped or cut. For some perspective, planned rotor removals typically only occur during scheduled major power plant shutdowns, about once every ten years or so at a cost of over $100,000. And if the large and heavy rotor accidentally hits the generator during such removal, repair costs can run into millions of dollars. Moreover, air gap baffle seals typically need to be replaced every five years or so and should be inspected every year or so.

There is thus a need for an air gap baffle seal that can be worked without removing the rotor, particularly for generators originally configured such that the rotor must be removed from the generator to work the air gap baffle seal. There is also a need for an air gap baffle seal with improved accessibility for generators originally configured with air gap baffle access without removing the rotor. There is also a need for a seal that can be worked in a confined space. There is also a need for an adaptable seal that can selectively expand and contract to allow, block, or restrict a gap flow. There is also a need for an adaptable seal that can contort into a predetermined area to make room for another object such as a skid plate or rotor.

### SUMMARY OF THE INVENTION

The present invention provides an air gap baffle seal that can be worked without removing the rotor, particularly for generators originally configured such that the rotor must be removed from the generator to work the air gap baffle seal. The present invention also provides an air gap baffle seal with improved accessibility for generators originally configured with air gap baffle access without removing the rotor. The present invention also provides a seal that can be worked in a confined space. The present invention also provides an adaptable seal that can selectively expand or contract to allow, block, or restrict a gap flow. The present invention also provides an adaptable seal that can contort into a predetermined area to make room for another object such as a skid plate or rotor.

One aspect of the present invention thus involves a seal system by which a seal located in a confined space can be worked, comprising an access structure removably attached to a first element, the access structure having a positioning channel; a second element set apart from the first element to provide a gap of not more than about two inches between the first element and the second element; and a seal having a securement portion sized and configured to be accepted into and retained by the positioning channel of the access structure and/or the first element.

Another aspect of the present invention involves adaptable seal system, comprising an access structure removably attached to a first element; a second element sleeved within the first element to provide a gap between the first element and the second element; and a seal adapted to attain a service orientation where the seal does not appreciably obstruct the gap, and an operation orientation where the seal essentially completely obstructs the gap.

Another aspect of the present invention involves an adaptable seal system, comprising a first element removeably attached to an access structure; a second element spaced a gap distance away from the first element; and a seal positioned between the first element and the second element adapted to selectively expand and contract in order to modify a flow amount in the gap.

Further aspects, features and advantages of the present invention will become apparent from the drawings and detailed description of the preferred embodiments that follow.

### BRIEF DESCRIPTION OF THE DRAWINGS

The above-mentioned and other concepts of the present invention will now be addressed with reference to the drawings of the preferred embodiments of the present invention. The illustrated embodiments are intended to illustrate, but not to limit the invention. The drawings contain the following figures, in which like numbers refer to like parts throughout the description and drawings and wherein:

FIG. 1 is a side elevation view of an exemplary generator;

FIG. 2 is an end view of the generator of FIG. 1, showing the air gap baffle seal of the present invention in relation to the stator coils, rotor, and air gap;

FIG. 3A is a detail side elevation view of FIG. 2 taken along cut line 3-3, showing the seal in a service mode where the seal is installed but not expanded;

FIG. 3B is a detail side elevation view of FIG. 2 taken along cut line 3-3 and similar to FIG. 3A, showing the seal in an operation mode where the seal is expanded;

FIG. 4A is a detail side elevation view similar to FIG. 3A, showing another embodiment of the present invention; and

FIG. 4B is a detail side elevation view similar to of FIG. 3B showing another embodiment of the present invention.

### DETAILED DESCRIPTION OF THE PREFERRED EMBODIMENT

The invention described herein employs several basic concepts. For example, one concept relates to an air gap baffle seal that can be worked without removing the rotor. Another concept related to a seal that can be worked in a confined space. Another concept relates to a removable access structure (e.g. ring) that provides access to an adaptable (e.g. inflatable) seal. Another concept relates to an adaptable gap seal that can selectively expand and contract to allow, block, or restrict a gap flow. Another concept relates to an adaptable seal that can contort into a predetermined area to make room for another object such as a skid plate or rotor.

The present invention is disclosed in context of an exemplary annular air gap baffle seal 24 located between a generator's rotor 18 and a generator's stator 14. The principles of the present invention, however, are not limited to air gap baffle seals used within generators, and can be used in connection with other generator areas such as a gland seal between the main shaft bearing and the rotor. The principles of the present invention can also be used with many other non-generator machines, structures, and locations that require working a seal in a confined space. One skilled in the art may also find additional applications for the apparatus, components, configurations and methods disclosed herein. Thus, the illustration and description of the present invention in context of exemplary air gap baffle seal located in or near a generator air gap 20 is merely one possible application of the present invention. However, the present invention has been found particularly suitable in connection with air gap baffle seals.

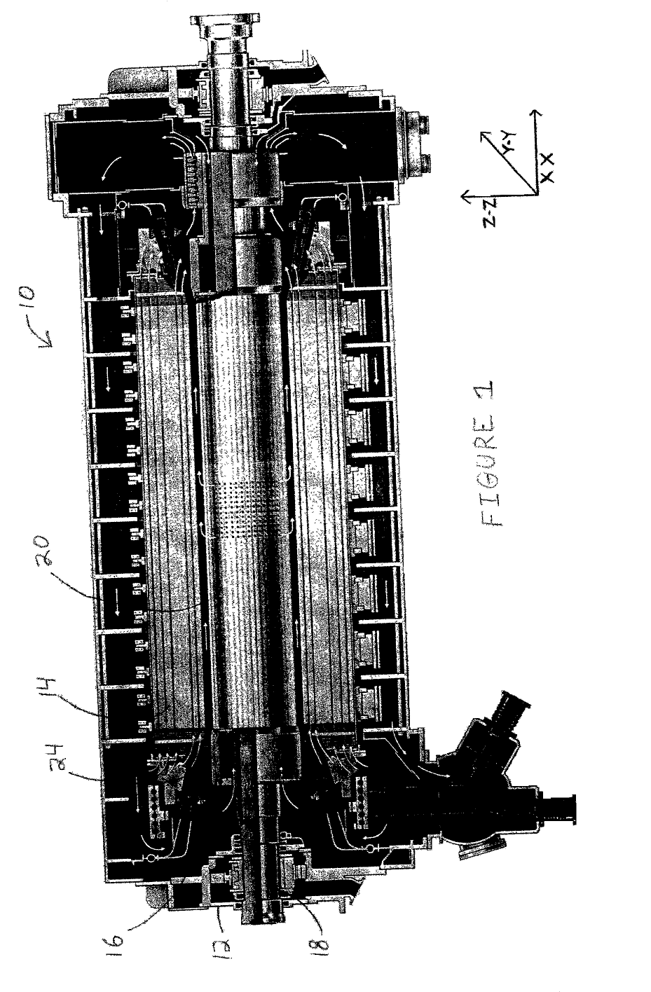

To assist in the description of the invention described herein, the following terms are used. Referring to FIG. 1, a “longitudinal axis” (X-X) extends along the major length of the rotor 18. A “lateral axis” (Y-Y) extends along the width of the rotor 18. A “transverse axis” (Z-Z) extends normal to both the longitudinal and lateral axes, and provides the third or height dimension of the rotor 18. In addition, as used herein, the “longitudinal direction” or “longitudinal length” refers to a direction substantially parallel to the longitudinal axis, the “lateral direction” or “lateral length” refers to a direction substantially parallel to the lateral axis, and the “transverse direction” or “transverse length” refers to a direction substantially parallel to the transverse axis. Further, “axial” and “radial” are used to describe relative direction, with “axial” describing a direction that is parallel to the longitudinal length of the rotor 18 and “radial” describing a direction that extends perpendicular from the nonrotating central axis of the rotor 18.

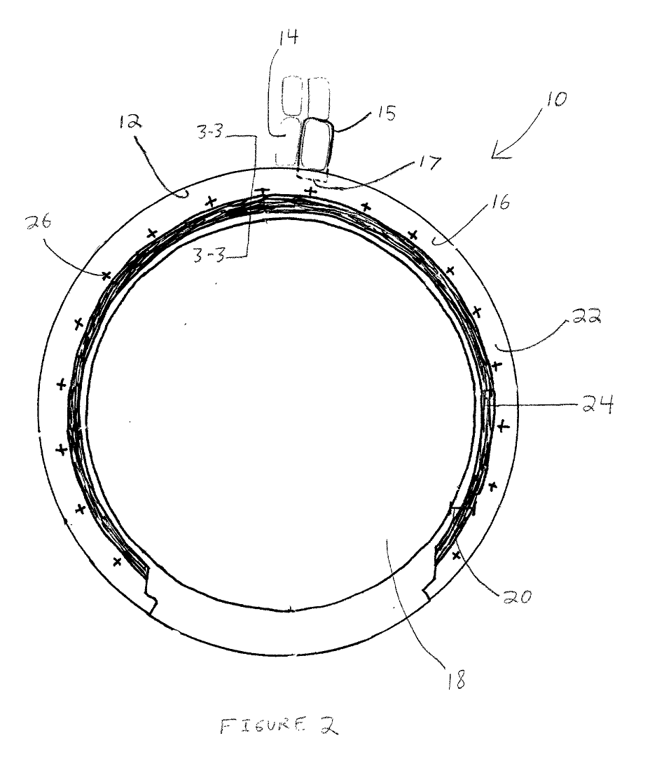

FIG. 2 shows an end 12 of the generator 10. The generator's parallel rings 16 are attached to the generator's stator coils 14 by suitable attachment means, such as being lashed around the coils 14 and through a lashing-hole 17 in the rings 16 with a dacron-glass epoxy cord 15, or by bolts, adhesives, and the like. Although only two pairs of coils 14 are shown around the ring 16 perimeter, the coils 14 typically surround the entire ring 16 perimeter and are attached thereto. The generator's rotor 18 is sleeved within the coils 14 and ring 16. An air gap 20 is defined by the annular space between the rotor 18 and the ring 16. The annular air gap 20 has a radial length that can easily range from about 0.05 inch to about 0.8 inch, depending on the type of generator, but can be much larger (e.g. over several inches) if used with other components. An access structure 22, described in more detail below, is removeably attached to the ring 16. An air gap baffle seal 24, described in more detail below, extends radially into the air gap 20.

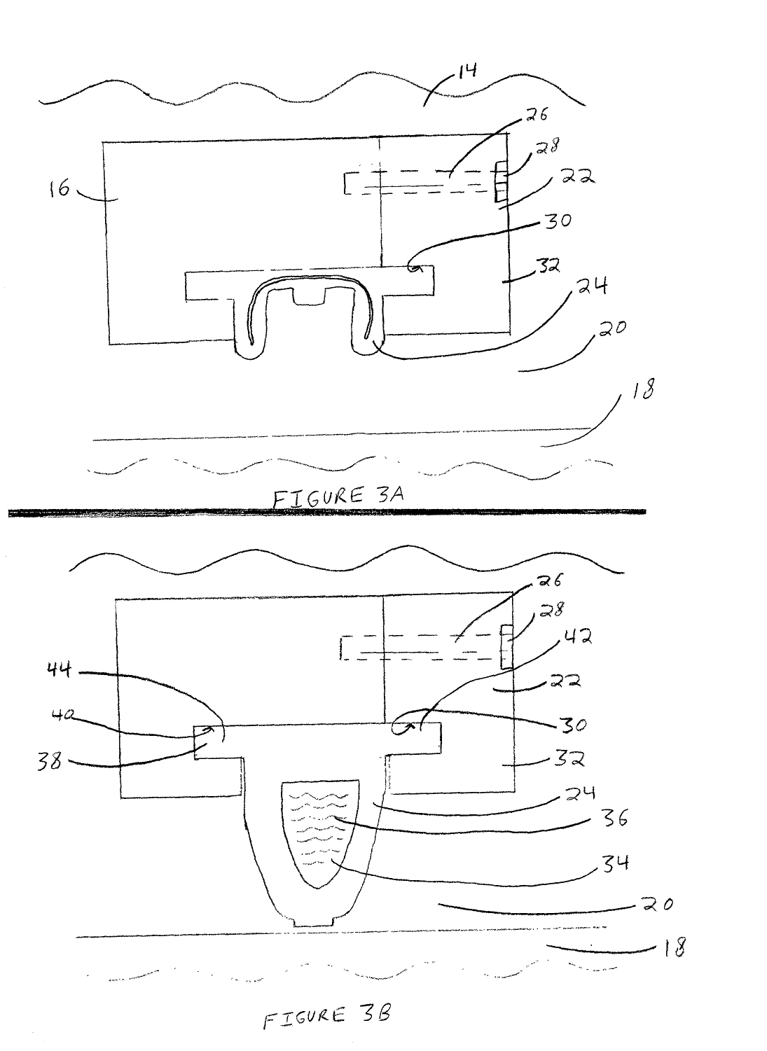

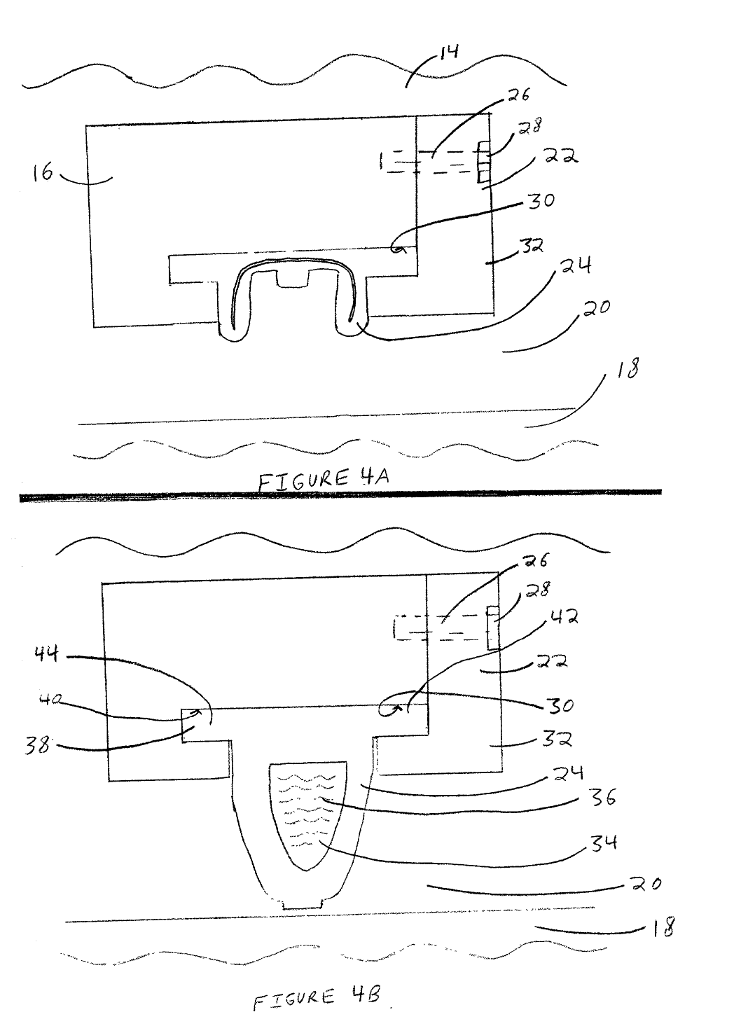

Referring now to FIGS. 2 and 3, the illustrated access structure 22 preferably has an annular configuration for ease of access to the entire annual baffle seal 24, which is particularly helpful when the baffle seal 24 must be replaced. The access structure 22, however, need not have an annular configuration, and can take on a variety of other configurations. For example, the access structure 24 can comprise two half-moon shapes, or a plurality of segments that collectively form an annular or some other shape.

The access structure 22 also has an axial length sufficient withstand applied forces from the ring 16 and baffle seal 24. The axial length can vary from about 0.1 inch to about 20 inches, depending on the material from which it is made and the generator within which it is arranged. For example, if the access structure 22 is made of a fiberglass material similar to the rings 16 and used within a 4-pole hydrogen cooled generator, then the axial length should be about 4 inch to about 6 inches. For another example, if the access structure 22 is made of a fiberglass material and used within a 2-pole air cooled generator, then the axial length should be about 3 inches to about 5 inches.

The access structure 22 is attached to the ring 16 by a removable fastening means, such as bolts, threaded fasteners, clamps, clips, hook and loop assemblies, lock and key assemblies and the like. The illustrated embodiment shows the removable fastening means embodied as a plurality of bolts 26. The bolts 26 are advantageously arranged for easy removal and replacement, since removal and replacement is performed in the confined space environment. Also, if a bolt 26 is dropped during the removal or replacement process and not recovered, it could lead to harmful or even catastrophic consequences. The illustrated embodiment shows the bolt heads 28 generally parallel to the air gap 20 for ease of removal and replacement. The bolts 26 can also be configured to back into the ring 16 when removed to further inhibit being dropped, or a bolt keeper could be used.

A positioning channel 30 is formed on the access structure 22 and is sized and configured to accept and retain a portion of the baffle seal 24. The illustrated embodiment shows the positioning channel arranged radially along the access structure 22, with a width of about 1 to 5 inches and a depth of about 0.5 to 4 inches. The channel 30 need not be located toward a radial end 32 of the access structure 22 and can be positioned more toward the radial center of the access structure 22, which tends to increase the overall strength of the access structure 22. The positioning channel 30 need not be continuous and can rather comprise a plurality discrete segments or indents into which mating portions of the baffle seal 24 extend to collectively form an annular or some other shape, or can protrude from the access structure 22 to accept the baffle seal 24.

Referring to FIGS. 3, the baffle seal 24 is adaptable between a service orientation, where the baffle seal 24 does not appreciably obstruct the air gap 20 (FIG. 3A); and an operation orientation, where the baffle seal 24 essentially completely obstructs the air gap 20 (FIG. 3B). (For the exemplary context of use with a generator air gap baffle seal, a small gap, e.g. about 0.01 inch to about 0.1 inch, is preferred to inhibit service rubbing between the rotor 18 and the baffle seal 24; however, for other uses, complete obstruction of the air gap 20 may be preferred). The baffle seal 24 can also advantageously adapt to any other intermediary orientation between the service orientation and the operation orientation. Thus, when in operation orientation, the baffle seal 24 is adapted to extend through the air gap 20 to thereby completely or substantially obstruct and redirect coolant through the rotor windings. And, when in service orientation, the baffle seal 24 is adapted not to appreciably extend into the air gap 20 to increase the amount of available space to work the baffle seal 24.

The adaptability of the baffle seal 24 can be achieved by a variety of means. For example and as illustrated, the baffle seal 24 can have a hollow portion 34 tillable with a medium 36 such as gas (e.g. air, hydrogen) fluid (e.g. water, hydraulic fluid), gel (e.g. silicone, epoxy), flexible and/or resilient solid or semi-solid materials (e.g. silicone, rubber, epoxy) combinations thereof, and the like. A suitable seal is commercially available from the Seal Master Corporation of Kent, Ohio under the tradename Seal Master. This exemplary inflatable seal can be constructed of a variety of materials such as hard or soft rubber, neoprene, nylon, plastic, fabric, combinations thereof and the like; and can also be reinforced or impregnated with fiber or other materials. For another example, the baffle seal 24 can be formed of an expandable material that expands during typical generator operating environments such as at temperatures above 120° F. or a compressible material that compresses under certain pressures or vacuums, such as elastomers, metals, springs and the like. Another type of material includes foam rubber and the like, which can be selectively compressed with the application of a vacuum or sub-atmospheric pressure and the like. These expandable and/or compressible materials can also be B-staged or otherwise partially cured so that it fully cures and hardens at certain temperatures or pressures.

The baffle seal 24 has a securement portion 38 that secures the baffle seal 24 to the rings 16 and/or access structure 22. The illustrated embodiment shows the securement portion 38 sized and configured for acceptance into and retention by the positioning channel 30 in the access structure 22 and a similar channel 40 formed in the ring 16. The illustrated securement portion 38 advantageously uses a pair of legs 42, 44 to perform this function, each having a length of about 0.5 inch to about 5 inches. The legs need not have the same length. Securement portions 38 having configurations other than legs can be used, such as barbs, fingers and the like.

By the above assemblies and configurations, when the baffle seal 24 is to be worked, it 24 is placed in the service orientation. Thus, for example, if the baffle seal 24 is embodied as an inflatable seal, the medium 36 is removed from the hollow portion 34. An operator can then remove the bolts 26 from the access structure 22 and separate the access structure 22 from the ring 16, thereby exposing the baffle seal 24. With the baffle seal 24 exposed, the operator can then work the baffle seal 24.

If the baffle seal 24 is to be removed, this can be done by pulling on one or more portions of the baffle seal 24 to loosen it 24 from within the positioning channel 40 or other structure by which it 24 is retained. A noteworthy feature of the illustrated embodiment is easy removal of the baffle seal 24 once it 24 is exposed. Moreover, this easy removal can be customized to suit a variety of applications. For example, such removal can range from the baffle seal 24 naturally falling out of the positioning channel 40 once the access structure 22 is removed, to requiring significant operator effort with the assistance of tools to remove the baffle seal 24 from the positioning channel 40. The desired amount of ease can be can be obtained by modifying the depth, width, height of the positioning channel 40 with respect to the leg 44, or the materials from which the leg 44 or channel 40 is made, and the like as will be understood by one skilled in the art. For example, if a tight fit is desired, then the width of the channel 40 could be narrower than the width of the leg 44 and the leg could be constructed of a compressible material to fit within the channel 40 upon application of a compressive force. For another example, if a loose fit is desired, then the depth of the channel 40 could be less than about 2 inches. In context of use with the exemplary generator air gap, a tight fit is typically desired due to air velocities of about 300 miles per hour.

Also by the above assemblies and configurations, at least a portion of the baffle seal 24 can be contorted or moved into a predetermined area to make room for another object. For example, the portion of the baffle seal adjacent the open area 50 of the access structure 22 can contort or move into the open area 50 and therein be protected from being torn or cut by the skid plate (not shown) or rotor 18 when the skid plate is used to help remove or insert the rotor 18 into the generator 10.

Although this invention has been described in terms of certain exemplary uses, preferred embodiments, and possible modifications thereto, other uses, embodiments and possible modifications apparent to those of ordinary skill in the art are also within the spirit and scope of this invention. It is also understood that various aspects of one or more features of this invention can be used or interchanged with various aspects of one or more other features of this invention. Accordingly, the scope of the invention is intended to be defined only by the claims that follow.

What is claimed is:

1. A seal system by which a seal located in a confined space can be worked, comprising:
an access structure removably attached to a first element, the access structure having a positioning channel;
a second element set apart from the first element to provide a gap of not more than about two inches between the first element and the second element; and
a seal having a securement portion sized and configured to be accepted into and retained by the positioning channel of the access structure and/or the first element.

2. The seal system of claim 1, wherein the confined space is an air gap between a generator rotor and a generator stator.

3. The seal system of claim 1, wherein the access structure has an annular shape.

4. The seal system of claim 1, wherein the access structure is removably attached to the first element by a plurality of bolts.

5. The seal system of claim 1, wherein the first element is a ring of a generator stator.

6. The seal system of claim 1, wherein the positioning channel is a channel having a depth of not more that about 4 inches and a width of not more that about 4 inches.

7. The seal system of claim 1, wherein the second element is a coil of a generator stator.

8. The seal system of claim 1, wherein the gap is about 0.05 to about 0.6 inches.

9. The seal system of claim 1, wherein the securement portion is a pair of legs respectively sized and configured to fit into the positioning channel of the access structure and the positioning channel of the first element.

10. The seal system of claim 9, wherein the legs respectively fit into the positioning channel of the access structure and the positioning channel of the first element upon being compressed by a compressive force.

11. An adaptable seal system, comprising:
an access structure removably attached to a first element;
a second element sleeved within the first element to provide a gap between the first element and the second element; and
a seal adapted to attain a service orientation where the seal does not appreciably obstruct the gap, and an operation orientation where the seal essentially completely obstructs the gap.

12. The seal system of claim 11, wherein at least a portion of the confined space is the air gap between a generator rotor and a generator stator.

13. The seal system of claim 11, wherein the first element is a ring of a generator rotor and the second element is a coil of a generator stator.

14. The seal system of claim 11, wherein at least a portion of the seal can be moved into a protected area to make room for another object.

15. The seal system of claim 11, wherein the seal is adapted to attain the service orientation and the operation orientation using a hollow portion that can be filled with a medium.

16. The seal system of claim 15, wherein the medium is selected from the group consisting of gas, fluid, gel, silicone rubber and combinations thereof.

17. The seal system of claim 15, wherein the seal is made of a rubber material.

18. The seal system of claim 15, wherein when the hollow portion is filled with the medium, the seal expands into the gap and attains the operation orientation.

19. The seal system of claim 15, wherein when the hollow portion is not filled with the medium, the seal does not expand into the gap to attain the service orientation.

20. The seal system of claim 15, wherein the seal completely obstructs the gap.

21. An adaptable seal system, comprising
a first element removeably attached to an access structure;
a second element spaced a gap distance away from the first element; and
a seal positioned between the first element and the second element adapted to selectively expand and contract in order to modify a flow amount in the gap.
